(19) United States
(12) Patent Application Publication
(10) Pub. No.: US 2012/0027388 A1
(43) Pub. Date: Feb. 2, 2012

(54) ADAPTIVE HEAT PUMP RESISTANCE HEAT CONTROLLER

(76) Inventor: Robert L. Fehr, Lexington, KY (US)

(21) Appl. No.: 12/846,352

(22) Filed: Jul. 29, 2010

(51) Int. Cl. F24H 3/04; H05B 1/02

(52) U.S. Cl. 392/349; 219/494

(57) ABSTRACT

An electrical heating apparatus includes a primary heating stage heat pump, a secondary heating stage resistance heating circuit having a plurality of heating elements, an adaptive resistance heat controller and a two-stage thermostat. The adaptive resistance heat controller is connected to the two-stage thermostat heat pump and resistance heating circuit. The adaptive resistance heat controller includes a duty cycle monitor that monitors the duty cycles of the thermostat primary and secondary stages. The controller selectively energizes one or more of the plurality of heating elements in response to changes in the duty cycles so as to provide adaptive heating control to meet actual heating demand while reducing overall peak energy consumption.

### TECHNICAL FIELD

The present invention relates generally to the electrical heating system field and, more particularly, to an electrical heating apparatus and method for more efficiently and economically heating an area to a desired temperature using primary and secondary heating sources.

### BACKGROUND OF THE INVENTION

One conventional heating and cooling device for conditioning air in a living space comprises a heat pump system. Heat pump systems use a refrigerant to carry thermal energy to cool or heat the air in the conditioned space as determined by a user thermostat. Under certain operating conditions it is known that a heat pump alone cannot provide enough heat to meet demand. Accordingly, heat pump systems typically incorporate a secondary resistance heating circuit that operates when the difference in indoor and outdoor air temperature reduces the efficiency of the heat pump so that heat pump operation alone fails to meet demand.

The present invention relates to an electrical heating apparatus incorporating a primary heating stage heat pump and a secondary heating stage resistance heating circuit in combination with an adaptive resistance heat controller. The controller divides the resistance heating circuit into a plurality of adaptive secondary heating stages which are then adaptively driven to meet secondary heat demand while also resulting in a reduction in peak electrical demand.

### SUMMARY OF THE INVENTION

In accordance with the purposes of the present invention as described herein, an electrical heating apparatus is provided. That heating apparatus comprises a primary heating stage heat pump, a secondary stage resistance heating circuit having a plurality of heating elements, an adaptive resistance heat controller connected to the heat pump and the resistance heating circuit and a two-stage thermostat connected to the controller. The adaptive resistance heat controller includes a duty cycle monitor that monitors the duty cycle of the thermostat primary and secondary stages (heat pump and resistance heating circuit respectively). The controller selectively energizes one or more of the plurality of heating elements in response to change in the duty cycle so as to provide adaptive heating control to meet actual heating demand while reducing overall peak energy consumption. The controller divides the resistance heating circuit into a plurality of adaptive secondary heating stages that are energized in response to detecting predetermined duty cycle levels for the thermostat secondary stage.

In accordance with yet another aspect of the present invention a method of heating an area with an electrical heating apparatus is provided. The method comprises monitoring changes in the duty cycles of the thermostat primary and secondary stages and selectively energizing one or more of the plurality of the heating elements of the resistance heating circuit of that heating apparatus in response to changes in the duty cycle so as to provide adaptive heating control to meet actual heating demand while reducing overall peak energy consumption.

More specifically, the method includes dividing the resistance heating circuit into a plurality of adaptive secondary heating stages and then energizing those stages in response to detecting predetermined changes in the duty cycle of the thermostat secondary stage.

In the following description there is shown and described several different embodiments of the invention, simply by way of illustration of some of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated herein and forming a part of the specification, illustrate several aspects of the present invention and together with the description serve to explain certain principles of the invention. In the drawings:

FIG. 1 is a schematical block diagram of the electrical heating apparatus of the present invention;

FIG. 2 is a schematical system diagram of the apparatus illustrated in FIG. 1;

FIGS. 3a and 3b are tables illustrating how the apparatus and method of the present invention provide a warmer supply air temperature for added user comfort and how utilities benefit from reduced peak demand at monitored outdoor air temperatures;

FIG. 4 is a table illustrating a heating apparatus of the present invention equipped with four equal size secondary heating stages; and

FIG. 5 is a table illustrating a heating apparatus of the present invention equipped with three different size secondary heating stages.

Reference will now be made in detail to the present preferred embodiment of the invention, examples of which are illustrated in the accompanying drawings.

### DETAILED DESCRIPTION OF THE PREFERRED EMBODIMENTS OF THE INVENTION

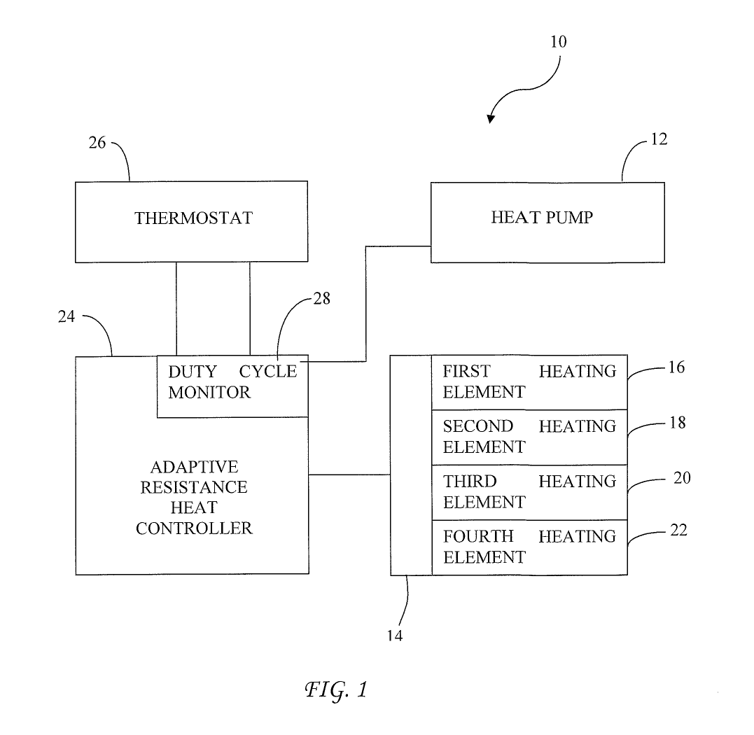

Reference is now made to FIG. 1 schematically illustrating the electrical heating apparatus 10 of the present invention. The heating apparatus 10 includes a primary heating stage heat pump 12 and a secondary heating stage resistance heating circuit 14. The resistance heating circuit 14 includes a first heating element 16, a second heating element 18, a third heating element 20 and a fourth heating element 22. While four heating elements 16, 18, 20, 22 are illustrated, it should be appreciated that the secondary heating stage resistance heating circuit 14 may include substantially any number of heating elements above one.

The electrical heating apparatus 10 also includes an adaptive resistance heat controller 24 and a two stage thermostat 26. The thermostat 26 is connected to the heat pump 12 through the adaptive resistance heat controller 24 which is also connected to the secondary heating stage resistance heating circuit 14. The adaptive resistance heat controller 24 may take the form of a dedicated microprocessor such as a PIC18F2585 microcontroller. The controller 24 divides the resistance heating circuit 14 into a plurality of adaptive secondary heating stages. In the illustrated embodiment there are four heating stages corresponding to the four heating elements 16, 18, 20, 22. It should be appreciated that a one-to-one correspondence between heating stages and heating elements 16, 18, 20, 22 is not required by the present invention. The controller 24 includes a duty cycle monitor 28 that monitors the duty cycle of the thermostat primary and secondary stages 26.

In operation the controller 24 energizes a first stage, in the illustrated embodiment the first heating element 16, in response to the monitor 28 detecting a first predetermined duty cycle level for the heat pump 12. The controller 24 further energizes a second stage, the second heating element 18 in the illustrated embodiment, in response to the monitor 28 detecting a second predetermined duty cycle level for the thermostat secondary stage. This second stage or second heating element 18 is energized in combination with the first stage/first heating element 16.

The controller 24 further energizes a third stage/third heating element 20 in response to the monitor 28 detecting a third predetermined duty cycle level for the thermostat secondary stage. The third stage/third heating element 30 is energized in combination with the first and second stages/heating elements 16, 18 of the resistance heating circuit 14. Still further, the controller 24 energizes a fourth stage/fourth heating element 22 in response to detecting a fourth predetermined duty cycle level for the thermostat secondary stage. This fourth heating element 22 is energized in combination with the first, second and third stages/heating elements 16, 18, 20.

The method of the present invention will now be described in detail. The method allows the heating of an area with an electrical heating apparatus 10 including a controller 24, a primary heating stage heat pump 12 and a secondary heating stage resistance heating circuit 14 having a plurality of heating elements 16, 18, 20, 22. The method may be broadly described as comprising monitoring changes in the duty cycles of the thermostat primary and secondary stages 26 selectively energizing one or more of the plurality of heating elements 16, 18, 20, 22 of the resistance heating circuit 14 in response to changes in the duty cycle so as to provide adaptive heating control to meet actual heating demand while reducing overall peak energy consumption.

The method may be further described as including dividing the resistance heating circuit 14 into a plurality of adaptive secondary heating stages. In the illustrated embodiment the heating stages correspond to the heating elements 16, 18, 20, 22.

The first predetermined change in the duty cycle is selected from a group of changes consisting of (1) detecting a predetermined duty cycle level and (2) detecting a predetermined increase in change in the duty cycle level from a first duty cycle to a second duty cycle.

The method further includes energizing a second stage of the adaptive secondary heating stages in response to detecting a second predetermined duty cycle level for the thermostat secondary stage. The second stage/second heating element 18 is energized in combination with the first stage/first heating element 16 of the resistance heating circuit 14.

The method also includes the step of energizing a third stage/third heating element 20 in response to detecting a third predetermined duty cycle level for the thermostat secondary stage. The third stage/third heating element 20 is energized in combination with the first and second stages/heating elements 16, 18 of the resistance heating circuit 14.

In accordance with yet another aspect of the present invention the method includes energizing a fourth stage/fourth heating element 22 in response to detecting a fourth predetermined duty cycle level for the thermostat secondary stage in combination with the first, second and third stages/heating elements 16, 18, 20. Still further, the method includes de-energizing the first adaptive secondary heating stage/heating element 16 in response to detecting a fifth predetermined duty cycle level for the heat pump 12. In addition, the method includes de-energizing the first and second adaptive secondary heating stages/heating elements 16, 18 in response to detecting a sixth predetermined duty cycle level for the heat pump 12. Further, the method includes de-energizing the first, second and third adaptive secondary heating stages/heating elements 16, 18, 20 in response to detecting a seventh predetermined duty cycle level for the thermostat secondary stage.

Finally, the method includes de-energizing the first, second, third and fourth secondary heating stages 16, 18, 20, 22 in response to detecting an eighth predetermined duty cycle level for the thermostat secondary stage. All together, the various combinations and permutations provided by the apparatus 10 and present method provide seven steps of heating stage control and thirteen duty cycles to provide a more comfortable living environment. One of the advantages of the apparatus 10 and method is that when possible one or more of the supplemental/secondary heating elements 16, 18, 20, 22 are allowed to remain on to improve the comfort level in the home.

The following example is presented to further illustrate the invention.

### EXAMPLE 1

Under normal operation, a standard heat pump thermostat 26 has the ability to trigger primary and secondary heat stages based upon the current and desired temperature. The primary stage operates the primary heat source, heat pump 12, while the second stage provides additional heat when needed. The first situation is when the heat pump 12 alone can provide enough heat to meet demand. The second is when the difference in indoor and outdoor air temperature reduces the efficiency of the heat pump 12, making a secondary source of heat, resistance heating circuit 14, necessary.

Typically, the second heat stage will provide a single heat source which in turn increases the peak demand of electricity. The adaptive heat pump resistance heat controller 24 expands the second heat stage into four incremental stages of heating. Each stage is dependent on the previous stages duty-cycle. It is anticipated that dividing this stage into four smaller sub-stages, which are adaptively driven by secondary heat demand, will result in a reduction of peak electrical demand.

In addition, the thermostat 26 turns on the second heat stage when the indoor air temperature is a fixed differential, 2 degrees, below the set point even if the primary heat source 12 could meet the demand if given sufficient time. This situation occurs when the home owner raises the thermostat setting quickly. The adaptive heat pump resistance heat controller 24 prevents this from occurring.

Definitions

Duty-cycle=the proportion of time during which a component is on. The duty cycle can be expressed as a ratio or as a percentage. Example: a heat pump operates for 9 minutes, then is shut off for 3 minutes, then is on for 9 minutes again, and so on. Its duty cycle is therefore 9/12, or 75%.

Cycle-time=the time for a component to complete an entire on/off cycle. In the previous example the cycle time would be 12 minutes.

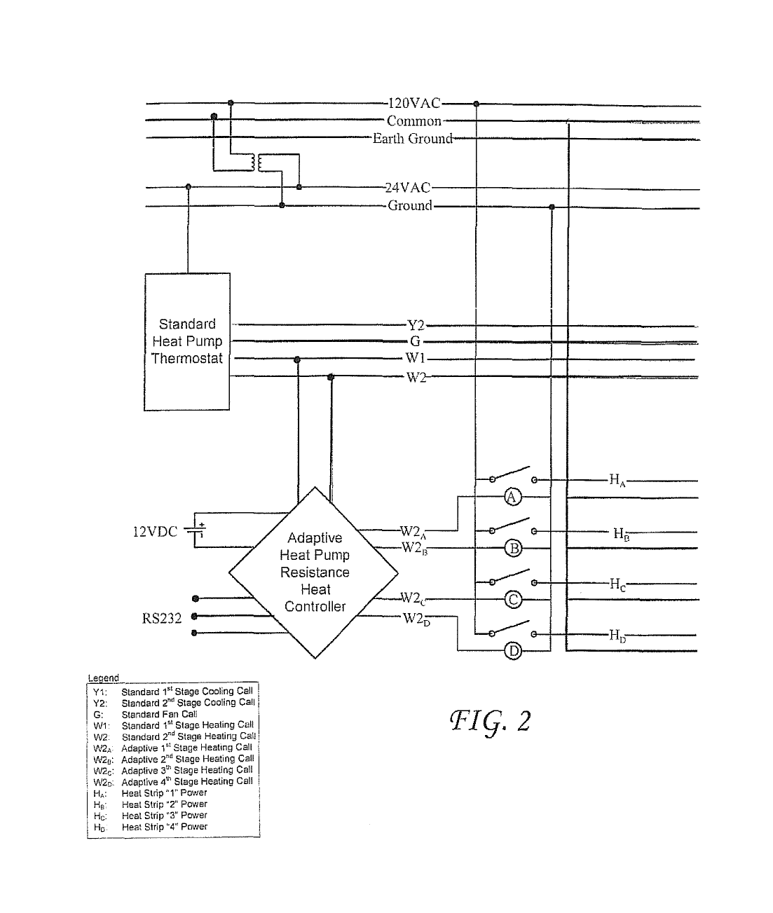

Inputs (See FIG. 2)

2-28 VAC (Heat Stage 1 & 2)

12 VDC (Controller Power)

RS232 (Communication)

Outputs (See FIG. 2)

4-28 VAC (Adaptive Heat Stages 1, 2, 3, & 4)

RS232 (Communication)

Algorithm Cycle

Step 1—Engaged when primary heat source duty-cycle=>95%

If a secondary heat source is demanded, the first adaptive stage is allowed to be switched on.

Step 2

If the first adaptive stage duty-cycle reaches 95%, the second adaptive stage is also turned on when a secondary heat source is demanded. The first adaptive stage switched+second adaptive stage switched is only disabled after the Step 2 duty-cycle is reduced to 41%.

Step 3

If the Step 2 duty-cycle reaches 60%, the first adaptive stage is turned on continuously and when a secondary heat source is demanded the second adaptive stage is allowed to be switched on. The first adaptive stage on+second adaptive stage switched is only disabled after the Step 3 duty-cycle is reduced to 13%.

Step 4

If the Step 3 duty-cycle reaches 95%, the third adaptive stage is also turned on when a secondary heat source is demanded. The first adaptive stage on +second adaptive stage switched+third adaptive stage switched is only disabled after the Step 4 duty-cycle is reduced to 38%.

Step 5

If the Step 4 duty-cycle reaches 77%, the first adaptive stage and second adaptive stage are turned on continuously and when a secondary heat source is demanded the third adaptive stage is allowed to be switched on. The first adaptive stage on+second adaptive stage on+third adaptive stage switched is only disabled after the Step 5 duty-cycle is reduced to 23%.

Step 6

If the Step 5 duty-cycle reaches 95%, the first adaptive stage and second adaptive stage are turned on continuously and when a secondary heat source is demanded the third adaptive stage and fourth adaptive stage are allowed to be switched on. The first adaptive stage on+second adaptive stage on+third adaptive stage switched+fourth adaptive stage switched is only disabled after the Step 5 duty-cycle is reduced to 41%.

Step 7

If the Step 6 duty-cycle reaches 85%, the first adaptive stage, second adaptive stage and third adaptive stage are turned on continuously and when a secondary heat source is demanded the fourth adaptive stage is allowed to be switched on. The first adaptive stage on+second adaptive stage on+third adaptive stage on+fourth adaptive stage switched is only disabled after the Step 5 duty-cycle is reduced to 63%.

Note: The percentages above vary based on the size of the supplemental heat units. See the examples below.

Adaptive Heat Pump Controller Test Setup

The adaptive heat pump algorithm was implemented on a PIC18F2585 microcontroller which sampled the state of each thermostat, primary and secondary heat, every second. Changes in demand for primary or secondary heat were time-stamped and used to compute duty cycles for each.

The system included a toggle switch to allow for normal operation and adaptive staging of secondary heat.

Normal operation, the device simply measures the state of each thermostat and the wiring between the thermostats and the heat pump and secondary heat are directly connected.

Under adaptive mode the secondary heat lines were split into four individual sections to allow control of up to 4 stages of supplemental heat. These were turned on and off depending on the stage required.

All input and output voltages were standard 24 VAC signaling used in HVAC systems. The prototype for initial testing included lights to indicate what stages of supplemental heat were engaged.

A user interface was designed to allow data acquisition and adjustability into the adaptive heat pump controller. The interface used a RS-232 serial connection between the controller and a Windows-based PC. Custom software was written in Microsoft Visual Studio 2005 to process data received from the controller. This custom software, entitled Adaptive Controller V1, is available upon request from Robert L. Fehr. A selectable timeout was implemented to allow a user to change the maximum amount of time primary or secondary heat must be in demand before progressing to the next state.

Test Setup

The initial tests were conducted utilizing two 10 minute cycle time controllers that could be adjusted to any cycle time desired. One was used to simulate the operation of the first stage of a two stage thermostat that is normally used to control the heat pump compressor operation. As the outdoor temperature falls and the building requires more heat the percentage of time on of the primary stage, the duty cycle increases. The cycle time remained constant at 10 minutes for this test. This was a manual operation that allowed the primary stage, used to control the heat pump, of the thermostat to slowly increase the duty cycle until secondary heat was needed.

The second cycle time controller was used to simulate the operation of the second stage of a two stage thermostat that is normally used to control the supplemental heat. This required more careful operation to test because as the adaptive controller allows more supplemental heat to be added the duty cycle changes, see the following examples. The duty cycle changes as the additional supplemental heat increases and decreases. Results of this testing demonstrated that the prototype system was capable of operating as designed.

Adaptive Heat Pump Controller Benefits

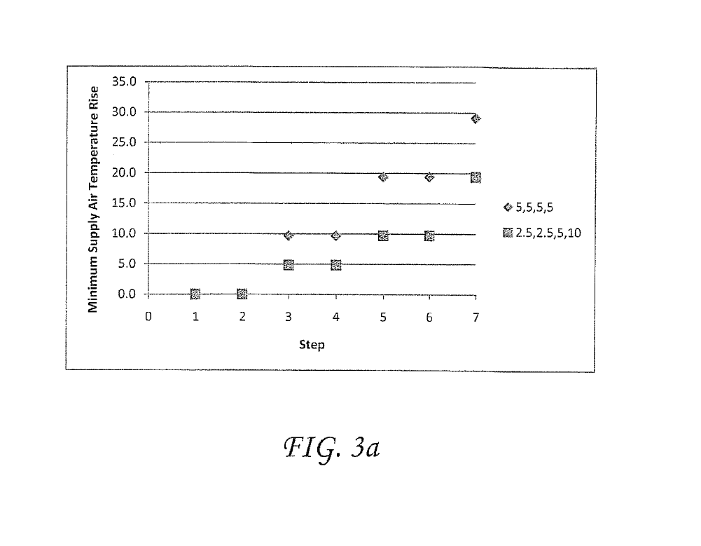

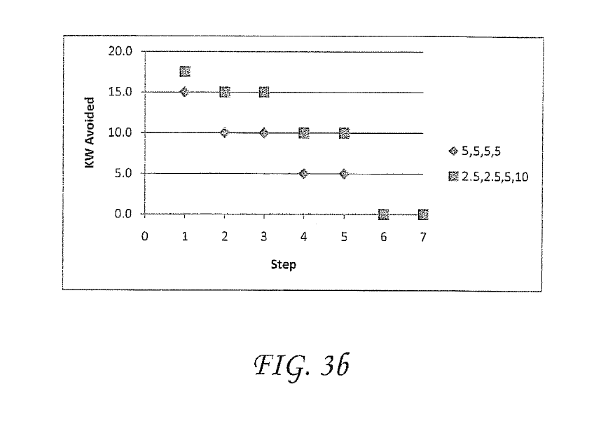

The adaptive heat pump controller benefits both the homeowner and the utility supplying the electricity. For the homeowner the controller provides a warmer supply air temperature as it keeps some stages on as more are required (see FIG. 3a). What is not clear from FIG. 3a is the outdoor air temperatures where the minimum supply air temperature rises would occur. With smaller additional supplemental heat stages, 2.5, 2,5, 5, 10, additional stages would be needed sooner raising the supply air temperature, thereby increasing comfort. In addition to increased comfort the adaptive controller would prevent secondary heat being used if not necessary when the thermostat is raised, reducing heating costs.

For utilities the benefit comes in reduced peak demand at moderate outdoor air temperatures (see FIG. 3b). For the systems shown in the examples the utility would normally see with entire 20 KW of load whenever secondary heat is required. With the adaptive controller the utility could see reductions depending on the size of the secondary heat stages. The result would be reduce demand load charges.

### EXAMPLE 1

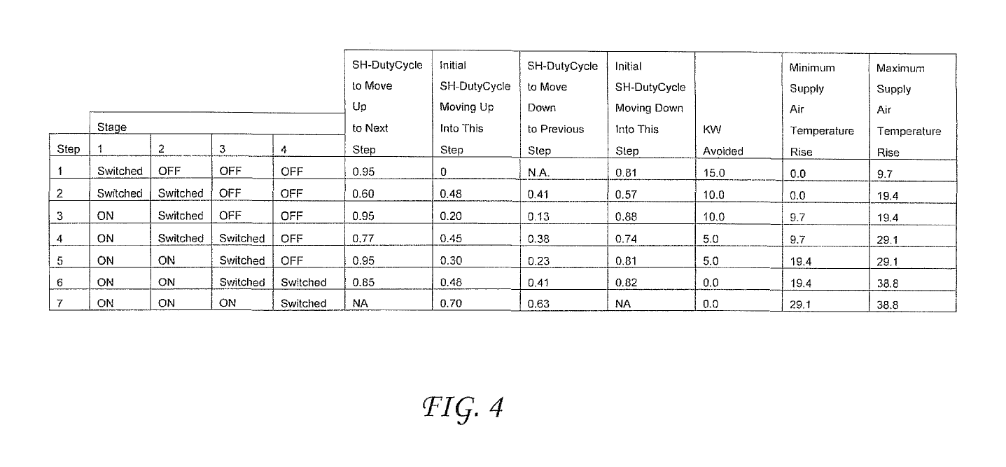

Four equal size secondary heat stages (please also see FIG. 4).

1600 Fan CFM

Btuh

| Stage | KW | per Stage | Cumulative |
|---|---|---|---|
| 1 | 5 | 17065 | 17065 |
| 2 | 5 | 17065 | 34130 |
| 3 | 5 | 17065 | 51195 |
| 4 | 5 | 17065 | 68260 |

| | |
|---|---|
| 0.95 | Fixed DutyCycle to Move to Next Step |
| 0.10 | Variable DutyCycle Increase to Move to Next Step |
| 0.07 | DutyCycle Decrease to Return to Previous Step |

Duty Cycle = Decimal factor of time from unit in active (on) compared to the time of a complete cycle of on and off
HP-DutyCycle = the decimal fraction of the total cycle time the thermostat calls for the Heat Pump to be on
SH-DutyCycle = the decimal fraction of the total cycle time the thermostat calls for Supplemental Heat to be on

### EXAMPLE 2

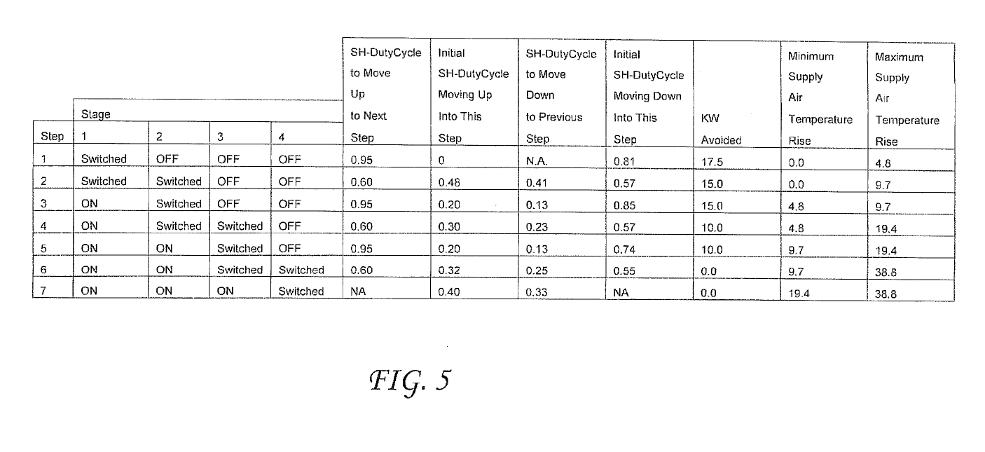

Using 3 different size secondary heat stages (please also see FIG. 5).

1600 Fan CFM

Btuh

| Stage | KW | per Stage | Cumulative |
|---|---|---|---|
| 1 | 2.5 | 8533 | 8533 |
| 2 | 2.5 | 8533 | 17065 |
| 3 | 5 | 17065 | 34130 |
| 4 | 10 | 34130 | 68260 |

| | |
|---|---|
| 0.95 | Fixed DutyCycle to Move to Next Step |
| 0.10 | Variable DutyCycle Increase to Move to Next Step |
| 0.07 | DutyCycle Decrease to Return to Previous Step |

Duty Cycle = Decimal factor of time from unit in active (on) compared to the time of a complete cycle of on and off
HP-DutyCycle = the decimal fraction of the total cycle time the thermostat calls for the Heat Pump to be on
SH-DutyCycle = the decimal fraction of the total cycle time the thermostat calls for Supplemental Heat to be on

The foregoing description of the preferred embodiments of the present invention have been presented for purposes of illustration and description. It is not intended to be exhaustive or to limit the invention to the precise form disclosed. Obvious modifications or variations are possible in light of the above teachings. The embodiments were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiments do not and are not intended to limit the ordinary meaning of the claims in their fair and broad interpretation in any way.

What is claimed:

1. An electrical heating apparatus, comprising:
a primary heating stage heat pump;
a secondary heating stage resistance heating circuit having a plurality of heating elements;
an adaptive resistance heat controller connected to said resistance heating circuit, said adaptive resistant heat controller including a duty cycle monitor that monitors a duty cycle of said electrical heating apparatus, said controller selectively energizing one or more of said plurality of heating elements in response to changes in said duty cycle so as to provide adaptive heating control to meet actual heating demand while reducing overall peak energy consumption; and
a two-stage thermostat connected to said controller.

2. The apparatus of claim 1, wherein said controller divides said resistance heating circuit into a plurality of adaptive secondary heating stages.

3. The apparatus of claim 2, wherein said controller energizes a first stage of said adaptive secondary heating stages in response to detecting a first predetermined duty cycle level for said heat pump.

4. The apparatus of claim 3, wherein said controller further energized a second stage of said adaptive secondary heating stages in response to detecting a second predetermined duty cycle level for the thermostat secondary stage in combination with said first stage of said adaptive secondary heating stages.

5. The apparatus of claim 4, wherein said controller further energized a third stage of said adaptive secondary heating stages in response to detecting a third predetermined duty cycle level for the thermostat secondary stage in combination with said first and second stages of said adaptive secondary heating stages.

6. The apparatus of claim 5, wherein said controller further energizes a fourth stage of said adaptive secondary heating stages in response to detecting a fourth predetermined duty cycle level for the thermostat secondary stage in combination with said first, second and third stages of said four adaptive secondary heating stages.

7. A method of heating an area with an electrical heating apparatus including a controller, a primary heating stage heat pump and a secondary heating stage resistance heating circuit having a plurality of heating elements, said method comprising:
monitoring changes in a duty cycle of said electrical heating apparatus; and
selectively energizing one or more of said plurality of heating elements of said resistance heating circuit in response to changes in said duty cycle so as to provide adaptive heating control to meet actual heating demand while reducing overall peak energy consumption.

8. The method of claim 7, including dividing said resistance heating circuit into a plurality of adaptive secondary heating stages.

9. The method of claim 8, including energizing a first stage of said adaptive secondary heating stages in response to detecting a first predetermined change in said duty cycle for said heat pump.

10. The method of claim 8, wherein said first predetermined change in said duty cycle is selected from a group of changes consisting of (1) detecting a predetermined duty cycle level and (2) detecting a predetermined increase in change of said duty cycle level from a first duty cycle to a second duty cycle.

11. The method of claim 9, including energizing a second stage of said adaptive secondary heating stages in response to detecting a second predetermined duty cycle level of the thermostat secondary stage in combination with said first stage of said adaptive secondary heating stages.

12. The method of claim 11, including energizing a third stage of said adaptive secondary heating stages in response to detecting a third predetermined duty cycle level of the thermostat secondary stage in combination with said first and second stages of said adaptive secondary heating stages.

13. The method of claim 12, including energizing a fourth stage of said adaptive secondary heating stages in response to a fourth predetermined duty cycle level of the thermostat secondary stage in combination with said first, second and third adaptive secondary heating stages.

14. The method of claim 9, including de-energizing said first adaptive secondary heating stage in response to detecting a fifth predetermined duty cycle level of the thermostat secondary stage.

15. The method of claim 11, including de-energizing said first and second adaptive secondary heating stages in response to detecting a sixth predetermined duty cycle level of the thermostat secondary stage.

16. The method of claim 12, including de-energizing said first, second and third adaptive secondary heating stage in response to detecting a seventh predetermined duty cycle level of the thermostat secondary stage.

17. The method of claim 13, including de-energizing said first, second, third and fourth adaptive secondary heating stages in response to detecting an eighth predetermined duty cycle level of the thermostat secondary stage.
